(19) United States
(12) Patent Application Publication
(10) Pub. No.: US 2005/0244662 A1
(43) Pub. Date: Nov. 3, 2005

(54) Fluoropolymer composites containing two or more ceramic fillers to achieve independent control of dielectric constant and dimensional stability

(76) Inventors: Allen F. Horn III, Danielson, CT (US); Robert C. Daigle, Sterling, CT (US); Michael S. Kuszaj, Dayville, CT (US)

Correspondence Address: CANTOR COLBURN, LLP, 55 GRIFFIN ROAD SOUTH, BLOOMFIELD, CT, 06002, US

(21) Appl. No.: 11/083,551

(22) Filed: Mar. 18, 2005

Related U.S. Application Data
(63) Continuation of application No. 08/283,301, filed on Jul. 29, 1994, now abandoned.

(51) Int. Cl. B32B 15/08

(52) U.S. Cl. 428/469; 428/421; 428/701

(57) ABSTRACT

A dimensionally stable high K′ microwave laminate comprises independent control of the K′ and CTE (coefficient of thermal expansion) of the fluoropolymer microwave laminates. The laminate comprises a composite having at least two types of ceramic filler. At least one type of ceramic filler exhibits a K′ of greater than 30. The two or more fillers are necessary to be able to independently control the K′ and the CTE of the composite, thereby achieving a dimensional stability of absolute magnitude less than 0.1% change. The present invention allows the manufacture of microwave laminate with any specified K′ (within the achievable range) and the XY CTE of the material nearly matched to that of copper, resulting in good dimensioned stability during circuit fabrication.

### BACKGROUND OF THE INVENTION

This invention relates generally to filled fluoropolymeric composites. More particularly, this invention relates to a fluoropolymeric composite for use as an electrical substrate material which exhibits both a high dielectric constant (K′) and a low coefficient of thermal expansion (CTE).

Fluoropolymer (predominantly PTFE) matrix composites are widely used as substrates in the microwave frequency circuit board industry due to the excellent electrical properties, high temperature resistance and outstanding solvent resistance of PTFE. These materials are often supplied as copper foil-clad sheets. The copper foil is generally attached to the fluoropolymer dielectric layer by lamination in a flat bed press or autoclave at a temperature above the melting point of the fluoropolymer dielectric.

When the sheets are processed into circuits, portions of the conductive foil are selectively removed and the sheet will undergo a dimensional change due to the strain relief. As will be understood by those skilled in the art, it is undesirable to have a circuit board which changes in dimension substantially when processed to remove a portion of the copper foil.

The problems associated with the dimensional stability of circuit board substrates in general is widely known throughout the circuit processing industry. The Institute for Interconnecting and Packaging Electronic Circuits (IPC) publishes a manual describing standard test methods for circuit materials (IPC-TM-650). IPC-TM-650 Method 2.2.4B describes the test for quantifying the dimensional stability of flexible dielectric materials upon complete removal by etching of the copper cladding. IPC-TM-650 2.4.39A describes the test method for measuring the dimensional stability of woven-glass reinforced thin laminates.

Many of the general types of fluoropolymeric circuit board substrates are described in “Specification for Plastic Substrates, Clad or Unclad for High Speed/High Frequency Interconnections” (Document IPC-L-125). The eight general types are described in sections IPC-L-125/01 to IPC-L-125/08.

Fluoropolymer substrate types 1 to 5 are low dielectric constant materials, with the K′ ranging from 2.15 to 2.65. These materials are composites of PTFE and glass fiber; types 1, 2 and 5 are reinforced with woven glass fabric while types 3 and 4 are reinforced with non-woven E-glass fibers.

With these types of materials, the dielectric constant and the dimensional stability both depend on the content of glass fiber reinforcement and cannot be independently controlled.

Rogers Corporation's RT/duroid® 5870 is a commercially available example of IPC-L-125 type 3 material, reinforced with approximately 13 weight % non-woven E-glass fibers. RT/d 5870 exhibits a K′ of 2.33 and a specified maximum dissipation factor of 0.0012. A 0.010″ thick specimen of RT/d 5870 exhibits dimensional shrinkage of about 0.1% in the machine direction and 0.2% in the cross machine direction when tested by the IPC dimensional stability method.

Rogers' RT/duroid 5880 is a commercially available example of IPC-L-125 type 4 material, reinforced with approximately 8 weight % non-woven, E-glass, with improved electrical properties. RT/d 5880 exhibits a K′ of 2.20 and a maximum specified dissipation factor of 0.0009. The improvement in the electrical performance of this material is due to the lower content of the E-glass reinforcement. The reduction in the E-glass content, however, results in poorer dimensional stability due to the greater mis-match between the CTE of the copper cladding and that of the fluoropolymeric composite substrate. A 0.010′ thick sample of RT/duroid 5880 will exhibit dimensional shrinkage of about 0.2% in the machine direction and 0.4% in the cross machine direction when tested by the IPC method. The larger dimensional change of RT/duroid 5880 increases the expense of circuit fabrication when this material is used. Special techniques such as “double etch” and strain relief are required to make precision microwave circuits when a substrate with the improved electrical properties and low E-glass content such as RT/duroid 5880 is required. An additional problem with substrates with a poor CTE match to copper is that they can exhibit substantial “curl” when the copper cladding is removed predominantly from one side of the material.

IPC-L-125 type 6 specifies a class of ceramic-powder filled, low K′ (K′< about 3) fluoropolymeric composite substrates. This type of fluoropolymer composite is also useful in certain applications for microwave laminates and is described in U.S. Pat. No. 4,849,284, assigned to the assignee hereof, all of the contents of which are incorporated herein by reference. A preferred embodiment of this invention is sold by Rogers Corporation to the microwave circuit board industry under the trademark RT/duroid® 6002. This composite material consists of approximately 60 volume % fused amorphous silica, about 39 volume % PTFE and about 1 volume % E-glass microfibers. It exhibits a K′ of 2.94, a Z-axis CTE of about 24 ppm/° C., an XY-axis CTE of about 17 ppm/° C. and a dimensional stability of about +0.05% when measured on a 0.010″ substrate. This small change in dimension upon removal of the copper cladding greatly facilitates the manufacture of precision circuitry and reduces the cost of fabrication. When the absolute change in dimension is less than about 1 mil/inch, the special processing such as the double etch and stress relief can be eliminated. The closer match of the composite CTE to that of the copper cladding also virtually eliminates problems associated with curl when the copper is removed from one side of the material.

One drawback of this material, however, is that the maximum dielectric constant attainable is about 3.0. A further drawback is that the dielectric constant cannot be varied (even below the highest attainable value of about 3) independently from the dimensional stability. A reduction in the silica filler content would be necessary to decrease the composite's K′; and that same reduction in filler content would cause the XY CTE of the composite to increase and result in poor dimensional stability.

A need also exists for comparatively high K′ (K′>4) fluoropolymeric composite materials such as those described in U.S. Pat. No. 4,335,180, assigned to the assignee hereof. Preferred embodiments of this invention are sold by Rogers Corporation under the trademark RT/duroid 6006 (K′=6.15) and RT/duroid 6010 (K′ of 10.2 to 10.8). This class of materials is generally made by adding titania ceramic filler to control the K′ of the material. The ceramic filler content also controls the material's CTE and dimensional stability.

It will be appreciated that independent control of K′ and CTE is not possible with the aforementioned single filler systems. A high K′ substrate with a K′ of 10.2 exhibits a z-axis CTE of about +45 ppm/° C. and a dimensional change upon etch and bake of about −0.2% to −0.4%. A high K′ substrate with a K′ of 6.15 exhibits a z-axis CTE of about +80 ppm/° C. and a very large dimensional change upon etch and bake of about −0.4% to −0.8%. These materials also exhibit significant curl when the copper foil cladding is removed from one side of the laminate, due to the poor match of composite CTE and cladding CTE.

The high z-axis CTE, the poor dimensional stability and the tendency to curl are all highly undesirable properties of these materials. Historically, designers and users of PTFE composite microwave circuitry have simply had to work around these deficiencies if a high K′ material was required. Thus, there continues to be a need for dimensionally stable, high K′ microwave laminates.

### SUMMARY OF THE INVENTION

The above-discussed and other problems and deficiencies of the prior art are overcome or alleviated by the fluoropolymeric composite of the present invention which is well suited for use as an electrical substrate. In accordance with the present invention, the fluoropolymer composite material contains more than one type (e.g., chemical composition) of ceramic filler. The object of the invention is to provide independent control of the K′ and CTE (e.g., dimensional stability) of fluoropolymer microwave laminates. This capability allows the manufacture of microwave laminates with any specified K′ (within the achievable range) and with an XY CTE of the material nearly matched to that of copper, resulting in good dimensional stability during circuit fabrication.

The composite material of this invention includes at least two types of ceramic fillers. At least one type of ceramic filler exhibits a K′ of greater than 30 while the other types of ceramic filler may exhibit a K′ of any value; although the second ceramic filler preferably has a K′ of less than about 30 to facilitate the use of conventional fillers and to facilitate the tailoring of the final dielectric constant for the laminate. The two or more fillers are necessary to be able to independently control the K′ and the CTE of the composite, thereby achieving a dimensional stability of absolute magnitude less than 0.1% change.

One application of the present invention is to make microwave laminates with the XY (in-plane) CTE of the composite nearly matched to that of copper and the K′ controlled to a specified value within the range of 3.0 to 20. This application of the present invention requires high filler contents; generally greater than 50 volume %. The CTE match is necessary to achieve good dimensional stability as measured by IPC TM 650 2.2.4B. K′ control to a specific value is often required to meet a specific application's electrical requirements; and therefore the ability of the present invention to be tailored to specific K′ values represents an important feature of this invention.

An additional advantage of the present invention is that low Z-axis CTE substrates with high K′ can be made, leading to better plated though-hole reliability.

The above-discussed and other features and advantages of the present invention will be appreciated and understood by those of ordinary skill in the art from the following detailed discussion and drawings.

### BRIEF DESCRIPTION OF THE DRAWINGS

Referring now to the drawings, wherein like elements are numbered alike in the several FIGURES:

FIG. 1 is a cross-sectional elevation view of an electrical substrate laminate in accordance with the present invention;

FIG. 2 is a graph showing the dimensional change versus the average XY-plane coefficient of thermal expansion (CTE);

FIG. 3 is a graph showing % change in dimension versus volume % silica filler;

FIG. 4 is a graph depicting how K′ increases with an increased level of titania filler; and

FIG. 5 is a graph depicting how dimensional change is affected by a change in the volume % of ash.

### DESCRIPTION OF THE PREFERRED EMBODIMENT

In the preferred embodiment, the invention consists of a composite fluoropolymeric (e.g., PTFE) material containing at least two chemically different ceramic fillers. The total volume fraction of the two fillers may cover the range of about 0.5 to 0.70 on a void-free basis, while the volume fraction of the fluoropolymer may range from about 0.3 to 0.5.

The total volume fraction of the combined fillers is effective to achieve a dimensional stability (also known as Dim Stab) of an absolute value of less than about 0.1%. As discussed in detail in the examples below, the volume loading of filler required to achieve this dimensional stability value will depend on the CTE of the two or more fillers, their particle size distributions (PSD) and particle morphology. In a preferred embodiment, improved dimensional stability occurs when the total volume filler loading is in the 0.5 to 0.7 range.

The fluoropolymeric matrix is most preferably polytetrafluoroethylene (PTFE), but may also comprises one or a combination of the following fluoropolymers: a copolymer of tetrafluoroethylene and perfluoroalkyl vinyl ether (PFA), a copolymer of hexafluoropropylene and tetrafluoroethylene (FEP), poly(ethylene-co-tetra fluoroethylene) and poly(vinylidene fluoride).

In general, one of the two fillers will be at least one “high-K′” filler which exhibits a K′ of greater than about 30. The second filler may have any K′. However, in a preferred embodiment, the second filler comprises at least one “low-K′” filler which will exhibit a K′ of less than about 30. Other properties of the fillers are also important to yield a useful microwave substrate. The fillers must both exhibit a relatively low dielectric loss (<0.005) at high frequencies (greater than 400 MHz). The particle size distribution and particle morphology must be such that they will result in a composite with relatively low (less than about 10 volume %) porosity as measured by uptake of a low surface tension solvent such as xylene. The particles themselves must also not exhibit significant porosity in order to make a low porosity composite.

Certain types of titania filler such as Tionia, manufactured by SCM Corporation meet these requirements and provide a good high-K′ filler. Other suitable first (high K′) fillers include SiTiO₃, C₂TiO₃ and BaTiO₄. Fused amorphous silica, such as Minsil-20, manufactured by Minsil, Incorporated or FB-35, manufactured by Denki Kagaku Kogyo, K.K. (DENKA) provides a good low-K′ filler. Other siliceous materials such as micro-crystalline silica or glass beads may equally well be used as a “second” or low-K′ filler. Still other suitable second (which may or may not be low K′) fillers include Al₂O₃, MgO and Ba₂Ti₉O₂₀.

Once the total volume loading of filler is set, the relative ratio of the two fillers comprising the desired volume loading is determined by the desired dielectric constant of the material. Using the SCM Tionia and Minsil-20 as the high-K′ and low-K′ fillers, respectively, a total volume content of filler of about 60% results in a circuit substrate that exhibits practically no dimensional change upon etch and bake when tested by the IPC method. To achieve a K′ of about 10, the volumetric ratio of titania to silica is set to approximately 50:10. To achieve a K′ of about 6, the volumetric ratio of titania to silica is set at about 34:26.

In the preferred embodiment of the invention, the two or more ceramic fillers are treated with a hydrophobic coating to improve the water absorption, ductility and copper bond strength of the fluoropolymeric composite material. Examples of efficacious and known hydrophobic coatings are silane coupling agents, titanates and zirconates.

The fluoropolymeric composite material may be fabricated by any of a number of methods previously described in both the patent and open literature. One fabrication process is essentially the same as the manufacturing process taught by Traut in U.S. Pat. No. 4,335,180, which is assigned to the assignee hereof and incorporated herein by reference. The process taught by Traut involves the dispersion of the ceramic filler and glass microfiber in water, the addition of fluoropolymer resin in dispersion form and the co-flocculation of the resin, filler and fiber. The present invention, however, does not require the incorporation of glass microfiber. The co-flocculated material is then lubricated with a hydrocarbon lubricant and formed into a sheet by paste extrusion and calendering. The content of hydrocarbon lubricant may vary form about 14% to 25% by weight, depending on the specific gravity, PSD, and morphology of the ceramic fillers.

A second fabrication process eliminates the use of water as a dispersant. In this “dry-blending” process, taught by Horn in Ser. No. 08/099,245, now U.S. Pat. No. ______, assigned to the assignee hereof and incorporated herein by reference, PTFE “fine powder” resin is blended with the ceramic fillers in a mixing device such as a Patterson Kelly Vee Blender along with the hydrocarbon lubricant and then formed into a sheet by paste extrusion and calendering.

A third fabrication process, taught by Swei et al in U.S. Pat. No. 5,312,576, assigned to the assignee hereof and incorporated herein by reference, causes the fillers and PTFE dispersion to be mixed and the viscosity increased with a viscosifying agent. The thickened mixture is then cast upon a carrier sheet and dried in an oven. The viscosifying agent is removed thermally and the composite material is sintered in a high temperature oven and released from the carrier sheet. This process is particularly well suited for the production of thin (less than 0.005′) sheets.

A number of methods may be used to apply the hydrophobic coating to the ceramic fillers. The fillers may be “pre-treated” as described by Arthur et al. in U.S. Pat. No. 4,849,284. The hydrophobic coating may also be introduced to the filler-PTFE mixture with the hydrocarbon lubricant as described in Ser. No. 08/099,235. The hydrophobic coating may also be introduced in the aqueous mixture of fillers and PTFE dispersion in the casting process. All of these processes have been practically demonstrated to improve the water absorption, ductility and copper peel strength over that of composites made with untreated filler.

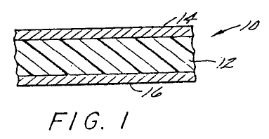

Referring to FIG. 1, the filled fluoropolymeric composite is depicted in the form of a circuit laminate 10 where the composite 12 comprises a dielectric sheet laminated between conductive sheets 14, 16 (preferably metal sheets such as copper or aluminum).

### EXAMPLES

The following non-limiting examples show the relationship between the laminates' XY coefficient of thermal expansion and the dimensional stability as measured by the IPC-TM-650 2.2.4b test. They further demonstrate the range of filler contents over which a good dimensional stability (absolute value of change of less than 0.1%) can be achieved and show the ability of the present invention to vary the K′ of the laminate without adversely affecting the dimensional stability.

### Example 1

The following examples demonstrates the relationship between the XY-plane coefficient of thermal expansion of a ceramic powder filled fluoropolymeric composite laminate and the dimensional stability as measured by IPC-TM-650 2.2.4b. Twelve different formulations of fused amorphous silica-PTFE composites were prepared with silica contents varying from about 50 volume % to 65 volume %. These materials were formed into sheets as described in Ser. No. 08/099,245 and laminated as 0.060″ thick sheets to 1 ounce/ft² electrodeposited copper foil in a flat bed lamination press.

The change in laminate dimensions was measured on the twelve formulations after complete copper removal and baking in accordance with the IPC-TM-650 test. Pieces of each formulation were also tested for coefficient of thermal expansion in the X and Y (in-plane) directions. Prior to CTE testing, the samples were heat-treated for stress relief. The heat-treating step consisted of placing the samples in an oven set to 700° F. for 30 minutes and then turning the heaters off and allowing them to slowly cool over a period of several hours to room temperature. The samples were tested for XY coefficient of thermal expansion over the temperature range of −55° to +288° C.

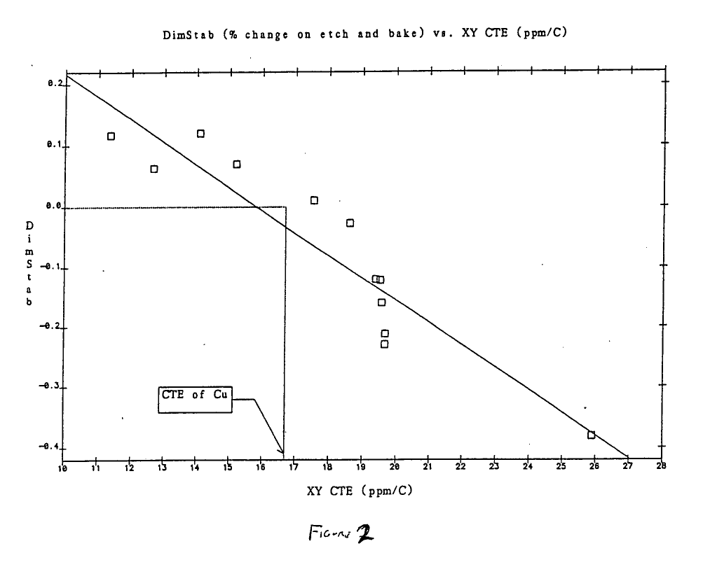

FIG. 2 displays the dimensional change (reported as % change upon etch and bake) versus the average XY-plane coefficient of thermal expansion. The markers on the plot show that when the measured CTE of the composite is about 16.7 ppm/° C. (matched to the CTE of the copper foil cladding), the dimensional change upon etch and bake is zero. This example clearly demonstrates that good dimensional stability can be achieved by matching the CTE of the composite material to that of the cladding foil. If the CTE of the composite material is higher than that of the foil cladding, the laminate will exhibit shrinkage when the copper is etched; if the CTE of the composite is lower than that of the foil cladding, the laminate will exhibit a positive dimensional change.

Furthermore, in order for the dimensional change to be less than about 0.1%, the composite XY-plane CTE must be within the range of greater than 11 ppm/° C. to less than 20 ppm/° C.

### Example 2

The following example demonstrates the relationship between filler volume loading and laminate dimensional stability for two different particle size distributions of filler.

The “Coarse PSD” sample of fused amorphous silica was produced by a dry ball milling process. It exhibited a median particle diameter of 9.5μ, with 85 weight % of the sample less than 29μ and 15% less than 4μ in equivalent spherical diameter as measured by the Shimadzu SA-CP4 particle size analyzer. The “Fine PSD” sample was produced by air classifying the Coarse PSD material and collecting the fines. The Fine PSD sample exhibited a 2.7μ median particle diameter, with 85 weight % of the sample less than 4.3μ and 15% less than 1.5μ.

Twenty formulations with Coarse PSD silica filler content ranging from 52% to 64% by volume were made into 0.060″ laminate by the method described in Ser. No. 08/099,245 and the dimensional stability of each was measured. An additional thirteen formulations with Fine PSD silica filler content ranging from 46% to 58% by volume were also made into 0.060″ laminate by the same method and the dimensional stability was also measured. The volume content of filler was measured by ashing the samples and is reported on a void-free basis.

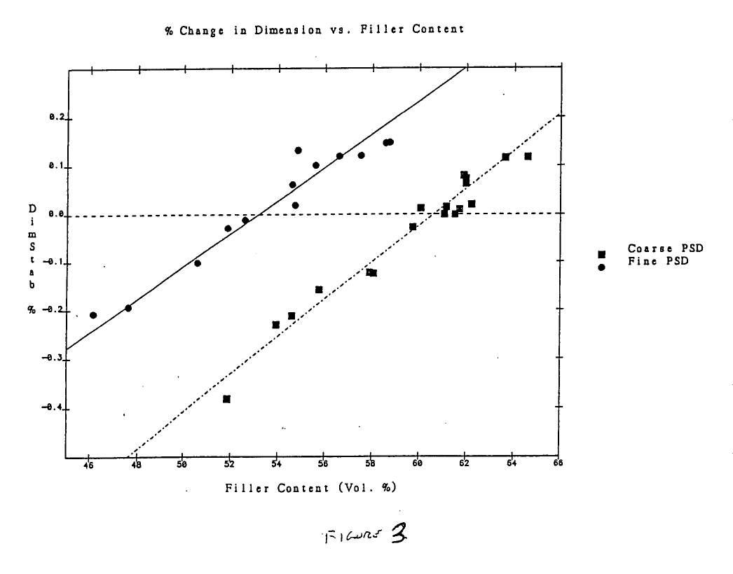

These data are plotted in FIG. 3 as % change in dimension versus volume % silica filler. The equations of the least-squares fit lines through these two data sets are:

Coarse PSD:
% Change=0.0384×(vol. % filler)−2.327

Fine PSD:
% Change=0.0342×(vol % filler)−1.816

The “zero dimensional change” condition (ZDC) occurs at a filler content of 60.6 volume % for the substrates prepared with the Coarse PSD silica and at a filler content of 153.1 volume % for the substrates prepared with the Fine PSD silica. The difference in volume fraction of filler required to achieve ZDC is due to the difference in the particle size distributions of the two filler samples. The Fine PSD silica exhibits a higher specific surface area. It is well known that higher surface area mineral fillers are more effective at decreasing the coefficient of thermal expansion of a polymeric composite.

From the slopes of the dimensional change versus filler content graphs, one can calculate that increasing the filler content by 2.6 percentage points from the ZDC condition (e.g. from 60.6% to 63.2%) results in a dimensional change of +0.1% for the substrates made with the Coarse PSD silica. A decrease in filler content of the same magnitude would result in a dimensional change of −0.1%. Similarly, one can calculate that a 2.9 percentage point increase in the Fine PSD filler content results in a dimensional change of +0.1%. Thus, in order to achieve a desirable dimensional stability in a ceramic powder filled PTFE composite, the volume content of filler must be within about 3 percentage points of that which results in zero dimensional change.

### Example 3

The following example demonstrates the ability to achieve good dimensional stability (less than 0.1% dimensional change) and maintain any desired dielectric constant within the range of about 4.0 to about 13 by utilizing a blend of two ceramic fillers. The good dimensional stability achievable with the present invention is compared with the poor dimensional stability of laminates made by the prior art.

Table 1 list the specific gravities and particle size distributions of both the high-K′ and low-K′ fillers used in this example.

TABLE I
Filler Specific Gravities
and
Particle Size Distributions

| | | | | |
|---|---|---|---|---|
| | | Diameter | Diameter | Diameter |
| Material | Sp.G. | 85% less than | Median | 15% less than |

| | | | | |
|---|---|---|---|---|
| A - High K′ | 3.98 | 20.4μ | 14.2μ | 10.6μ |
| TiO₂-I¹ | | | | |
| B - High K′ | 4.26 | 4.3μ | 2.9μ | 1.9μ |
| TiO₂-II² | | | | |
| C - Low K′ | 2.2 | 28.6μ | 9.5μ | 4.0μ |
| FB-35 | | | | |
| D - Low K′ | 2.2 | 26.2μ | 9.4μ | 3.0μ |
| Minsil-20 | | | | |
| E - Low K′ | 4.0 | 19.9μ | 13.6μ | 11.0μ |
| Al₂O₃³ | | | | |

¹“Tionia” from SCM Corporation
²“TICON” from Tam Ceramics, a Cookson Company
³“EGPA” from Norton Corporation

Table 2 compares K′, thickness and dimensional stability data for examples of the prior art including Rogers RT/duroid 6010, RT/duroid 6006 and Keene 810. The Rogers RT/duroid substrates were produced as taught by Traut '180. All of the prior art materials exhibit dimensional changes upon etch and bake of worse than −0.2%. All of these materials require the special fabrication techniques such as double etch and strain relief in order to be made into useful high frequency circuitry. They are also known to curl under certain circumstances, leading to further fabrication problems.

The Keene material was considerably worse than RT/d 6010 (about −0.7% change), probably due to the absence of glass microfiber. The dimensional change of the RT/duroid 6006 is much worse (−0.6% to −0.8%) than RT/d 6010 due to the low volume loading of filler. The filler content of the RT/d 6006 is decreased in order to achieve the desired K′ value of 6.15. The shrinkage and curl of RT/d 6006 is known to be unacceptable to circuit substrate fabricators.

These data demonstrate the severe limitations of prior art high-K′ circuit board substrates and the inability of the formerly existing technology to vary the K′ of a circuit substrate and maintain a good dimensional stability.

TABLE 2
Dimensional Stability, K′ and thickness data
for
Prior Art High-K′ PTFE Composite Circuit Substrates

| | | | |
|---|---|---|---|
| | | | Dimen. Stability |
| Material | Thickness | K′ | % Change |

| | | | | |
|---|---|---|---|---|
| RT/d 6010 | 0.010″ | 10.2 | MD | −0.20% |
| | | | CMD | −0.20% |
| RT/d 6010 | 0.050″ | 10.2 | MD | −0.22% |
| | | | CMD | −0.21% |
| RT/d 6006 | 0.010″ | 6.15 | MD | −0.81% |
| | | | CMD | −0.64% |
| RT/d 6006 | 0.050″ | 6.15 | MD | −0.56% |
| | | | CMD | −0.56% |
| Keene 810 | 0.025″ | 10.2 | MD | −0.70% |
| | | | CMD | −0.62% |

Table 3 displays dimensional stability, K′ and thickness data for the present invention. Samples 9901, 9902 and 9903 were produced by the method described by Swei in U.S. Pat. No. 5,312,576. Referring to table 3, sample 9901 was formulated to contain 45 vol. % filler B, 10 vol. % filler E and 45 vol. % PTFE on a void-free basis. Sample 9902 was made within 40 vol. % filler A, 15 vol. % filler E and 45 vol. % PTFE on the same basis. Sample 9903 contained 50 vol. % filler A, 10 vol. % filler C, and 40 vol. % PTFE. These materials all exhibited dimensional change upon etch and bake of an absolute value considerably less than 0.1%.

Sample 2039-53-4 was prepared by the method described by Horn in Ser. No. 08/099,245 and was formulated to contain 50 vol. % filler A, 10 vol. % filler C and 40 vol. % PTFE. This material exhibited practically no measurable change in dimension upon etch and bake.

TABLE 3
Dimensional Stability, K′ and thickness data
for
Novel High-K′ PTFE Composite Circuit Substrates
with two ceramic fillers

| | | | |
|---|---|---|---|
| | | | Dimen. Stability |
| Material | Thickness | K′ | % Change |

| | | | | |
|---|---|---|---|---|
| 9901 | 0.025″ | 10.5 | MD | −0.01% |
| | | | CMD | −0.01% |
| 9902 | 0.025″ | 9.6 | MD | −0.03% |
| | | | CMD | −0.04% |
| 9903 | 0.025″ | 10.5 | MD | +0.05% |
| | | | CMD | +0.06% |
| 2039-53-4 | 0.025″ | 10.4 | MD | +0.01% |
| | | | CMD | 0.00% |
| 2069-50-2 | 0.025″ | 5.5 | MD | −0.01% |
| | | | CMD | 0.000% |
| 2069-51-1 | 0.025″ | 6.3 | MD | −0.03% |
| | | | CMD | −0.01% |

Samples 2069-50-2 and 2069-51-1 were prepared using the method described by Swei. Both samples were formulated with a total filler content of 58 volume %. Sample 2069-50-2 was made with 23.3 volume % of filler A, 34.8 volume % filler D and 42 volume % PTFE. Sample 2069-51-1 was made with 29.0 volume % of filler A, 29.0 volume % filler D and 42 volume % PTFE. The two samples were laminated as 0.025″ sheet to copper foil and tested for dielectric constant and dimensional stability. As shown in table 3, both samples exhibited excellent dimensional stability. The dielectric constants of the samples were 5.5 and 6.3, respectively.

### Example 4

This examples demonstrates the capability of the present invention to achieve a d wide range of dielectric constants while maintaining a good dimensional stability of an absolute change of less than 0.1% when tested by IPC-TM-650 Test Method 2.2.4B.

Nineteen separate samples of PTFE-TiO₂—SiO₂ composite were prepared by the method described by Swei. The TiO₂ used in this example was filler A and the SiO₂ was filler D described in table 1. All nineteen samples had a total filler content of 57 to 61 volume %, the total filler consisting of a mixture of filler A and filler D. The titania content of the composite was varied from 0 to 50 volume % while holding the total filler content constant within the range of 57 to 61 volume %.

The materials were laminated to 1 oz/ft² copper foil and tested for dimensional stability and dielectric constant. All nineteen samples exhibited an absolute dimensional stability of less than 0.1%, in contradistinction to the prior art materials listed in table 2. The dielectric constant was tested at x-band by a stripline resonance method.

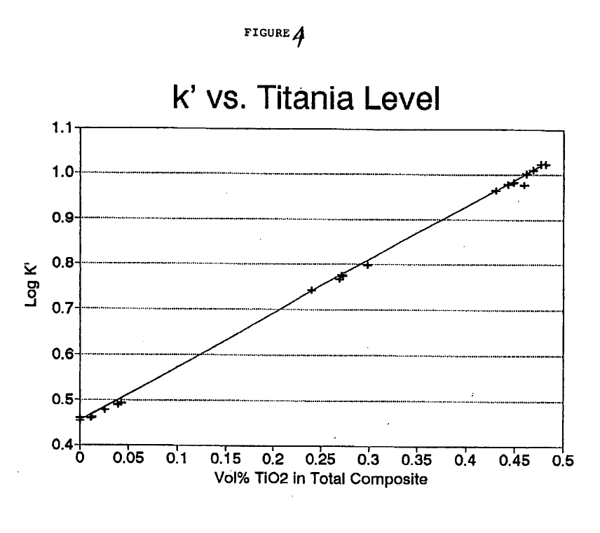

The dielectric constant results are plotted in FIG. 4 as log₁₀K′ versus the volume % of TiO₂ in the composite on a void-free basis. The data are fit by the equation
log₁₀K′=1.1896V_{TiO2}+0.4565
where V_{TiO2} is the volume fraction of titania in the composite. The graph demonstrates the wide range of dielectric constants that can be achieved while controlling the dimensional stability of the laminate. The data shown on the graph range from K′ of 2.9 to K′ of 10.2. Using the above equation to extrapolate the present data, a dielectric constant of 15.2 can be achieved with 61 volume % of filler. A PTFE composite containing 61 volume % of filler A titania would exhibit an absolute value of dimensional stability of less than 0.1%. The ability to vary dielectric constant over such a wide range without adversely changing the dimensional stability of the laminate material represents a vast improvement over the prior art materials.

### Example 5

This example demonstrates the capability of the present invention to “fine tune” the dimensional stability of a PTFE composite circuit substrate while maintaining a desired dielectric constant using the mixture of fillers. Nine composite samples were prepared using the method described by Swei. The material was formulated to contain from 57 to 61 volume % of total filler, the total filler consisting of a mixture of fillers A and D from table 1. The volume content of titania varied from 43.7% to 50.8%. The dielectric properties were measured at X-band frequency using a stripline resonator. The average K′ was 9.90 with a standard deviation, a of 0.46.

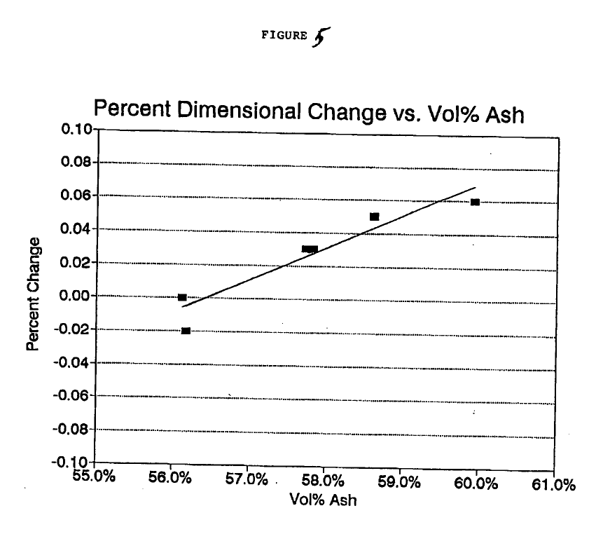

The actual filler content was determined by burning off the PTFE resin at 600° C. in a muffle furnace under a vacuum of 29″ of Hg. The dimensional stability was measured in accordance with IPC-TM-650 2.4.4B. All samples exhibited a dimensional change of less than 0.1%. However, FIG. 5 demonstrates that, at a total volume % of filler of 56.1%, a dimensional change of 0 can be achieved with the mixture of fillers.

While preferred embodiments have been shown and described, various modifications and substitutions may be made thereto without departing from the spirit and scope of the invention. Accordingly, it is to be understood that the present invention has been described by way of illustrations and not limitation.

1. An electrical circuit material comprising:
at least one metal layer on at least a portion of a surface of a substrate composite material, wherein the composite material comprises:
(1) a fluoropolymeric matrix;
(2) particulate ceramic filler material, wherein the volume percent of said fluoropolymeric matrix and the volume percent of said filler material together equal 100 percent, said filler material comprising a mixture of:
(a) at least one first ceramic material having a dielectric constant >30, wherein said first ceramic material is selected from the group consisting of titania, SrTiO₃, CaTiO₃ and BaTiO₄; and
(b) at least one second ceramic material selected from the group consisting of silica, fused amorphous silica, micro-crystalline silica, glass beads, Al₂O₃, MgO and Ba₂Ti₉O₂₀, said mixture of ceramic fillers being proportioned in a ratio effective to provide the composite material with a dimensional stability of absolute magnitude of less than about 0.1% change, and wherein the composite material has a dielectric constant of 3.0 to 20.0.

2. The material of claim 1 wherein:
said first ceramic material is and the second ceramic material is silica.

3. (canceled)

4. (canceled)

5. The material of claim 1 wherein:
said particulate filler material exhibits a dielectric loss of <0.005 at frequencies greater than 500 MHz.

6. The material of claim 1 wherein:
said fluoropolymeric matrix is present in an amount of between about 30 to 50 volume percent of the total substrate material and said filler material is present in an amount of between about 50 to 70 volume percent of the total substrate material.

7. (canceled)

8. (canceled)

9. The material of claim 1 including:
a hydrophobic coating on said ceramic materials.

10. The material of claim 9 wherein:
said coating on said ceramic materials is selected from the group consisting of silanes, titanates and zirconates.

11. (canceled)

12. The material of claim 1 wherein:
the metal layer comprises copper.

13. The material of claim 12 wherein said composite material has a planar shape and includes an X-Y plane and wherein:
the CTE of the composite material is substantially equal to the CTE of the copper.

14. The material of claim 1 wherein:
said fluoropolymeric matrix is selected from the group consisting of polytetrafluoroethylene, a copolymer of tetrafluoroethylene and perfluoroalkyl vinyl ether, a copolymer of hexafluoropropylene and tetrafluoroethylene, poly(ethylene-co-chlorotrifluoroethylene), poly(chlorotrifluoroethylene), poly(ethylene-co-tetrafluoroethylene) and poly(vinylidene fluoride).

15. The material of claim 1 wherein said composite material has a planar shape and includes and X-Y plane and wherein:
the coefficient of thermal expansion of said X-Y plane is within the range of greater than 11 ppm/° C. and less than 20 ppm/° C.

16. The material of claim 1 wherein said composite material has a planar shape and includes an X-Y plane and wherein:
the volume % of said mixture of ceramic fillers is within ±3 percentage points of the volume % of ceramic filler necessary for achieving a dimensional change of zero in said X-Y plane.

17. (canceled)

18. The material of claim 1 wherein said particulate ceramic filler is present in an amount of 60 volume % and wherein said first ceramic filler comprises titania; and
said second ceramic filler comprises silica.

19. The material of claim 18 wherein:
the volumetric ratio of titania to silica is about 50:10.

20. The material of claim 18 wherein:
The volumetric ratio of titania to silica is about 34:26.

21. An electrical circuit material comprising:
at least one metal layer on at least a portion of a surface of a substrate composite material, wherein the substrate composite material comprises:
(1) a fluoropolymeric matrix;
(2) particulate ceramic filler material, wherein the volume percent of said fluoropolymeric matrix and the volume percent of said filler material together equal 100 percent, said filler material comprising a mixture of:
(a) at least one first ceramic material having a dielectric constant >30, wherein said first ceramic material is selected from the group consisting of titania SrTiO₃ CaTiO₃ and BaTiO₃; and
(b) at least one second ceramic material selected from the group consisting of silica, fused amorphous silica, micro-crystalline silica, glass beads, Al₂O₃, MgO and Ba₂Ti₉O₂₀, said mixture of ceramic fillers being proportioned in a ratio effective to provide the composite material with a coefficient of thermal expansion within a range of greater than 11 ppm/° C. and less than 20 ppm/° C.; and wherein the composite material has a dielectric constant of 3.0 to 20.0.

22. An electrical circuit material comprising:
at least one metal layer on at least a portion of a surface of a substrate composite material, wherein the substrate material comprises:
(1) a fluoropolymeric matrix;
(2) particulate ceramic filler material, wherein the volume percent of said fluoropolymeric matrix and the volume percent of said filler material together equal 100 percent, said filler material comprising a mixture of:
(a) at least one first ceramic material having a dielectric constant >30, wherein said first ceramic material is selected from the group consisting of titania, SrTiO₃, CaTiO₃ and BaTiO₃; and
(b) at least one second ceramic material selected from the group consisting of silica, fused amorphous silica, micro-crystalline silica, glass beads. Al₂O₃, MgO and Ba₂Ti₉O₂₀, the volume % of said mixture of ceramic fillers being within ±3 percentage points of the volume % of ceramic filler necessary for achieving a dimensional change of zero, and wherein the composite material has a dielectric constant in the range from 3.0 to 20.0.

23. (canceled)

24. (canceled)

25. (canceled)
